(19) United States
(12) Patent Application Publication
(10) Pub. No.: US 2024/0257813 A1
(43) Pub. Date: Aug. 1, 2024

(54) STRUCTURED AUDIO CONVERSATIONS WITH ASYNCHRONOUS AUDIO AND ARTIFICIAL INTELLIGENCE TEXT SNIPPETS

(71) Applicant: ANECURE INC., San Francisco, CA (US)

(72) Inventors: Sudha Kanakambal VARADARAJAN, San Francisco, CA (US); Arish ALI, San Francisco, CA (US)

(21) Appl. No.: 18/632,130

(22) Filed: Apr. 10, 2024

Related U.S. Application Data
(63) Continuation of application No. PCT/IB2023/000331, filed on Feb. 3, 2023.
(60) Provisional application No. 63/307,011, filed on Feb. 4, 2022.

(51) Int. Cl. G10L 15/26; G06F 40/58; G10L 15/00

(52) U.S. Cl. CPC G10L 15/26; G06F 40/58; G10L 15/005

(57) ABSTRACT

In some aspects, each participant in a conversation can record their audio content separately, at their own time and post it to a conversation thread. This is an asynchronous format that does not rely on all participants being available at the same time. Further, each such audio content, may be automatically transcribed and processed to generate a small snippet(s) of text that is associated with the audio content. This results in a structured audio conversation media format that grows over time as participants add more replies. The structure makes it possible to quickly scan the conversation, see who has spoken and read their text snippets to gauge interest and then quickly navigate to portions of the audio content that are of more interest to the listener.

### CROSS-REFERENCE TO RELATED APPLICATION(S)

This application is a continuation of International Application No. PCT/IB2023/000331, “Structured Audio Conversations with Asynchronous Audio and Artificial Intelligence Text Snippets,” filed Feb. 3, 2023; which claims priority to U.S. Provisional Patent Application Ser. No. 63/307,011, “Structured Audio Conversations with Asynchronous Audio and AI Text Snippets,” filed Feb. 4, 2022. The subject matter of all of the foregoing is incorporated herein by reference in their entirety.

### BACKGROUND

### 1. Technical Field

This disclosure relates generally to audio content.

### 2. Description of Related Art

Audio content is becoming popular on the internet, from podcasts to various forms of live audio chats and more. Audio content is hard to consume quickly as it takes time to listen. While full text transcription may be available, that generates a large amount of text for even short conversations, making the consumption of such content very boring. Audio content with multiple speakers, where certain speakers are of more interest, is also hard to navigate as the recording is done synchronously as one large audio file and requires everyone to be present at the same time.

These problems have made audio almost a second class citizen in the internet media world. People tend to listen to audio while doing something else, such as driving a car, doing chores at home, etc., instead of fully engaging with audio content.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIGS. 1A and 1B are screens of a mobile app using structured conversations with text snippets according to embodiments of the present disclosure.

FIG. 2 is another screen of a mobile app using structured conversations with text snippets according to embodiments of the present disclosure.

FIG. 3 is yet another screen of a mobile app using structured conversations with text snippets according to embodiments of the present disclosure.

FIG. 4 is a screen of a website using structured conversations with text snippets according to embodiments of the present disclosure.

FIG. 5 is another screen of a website using structured conversations with text snippets according to embodiments of the present disclosure.

FIG. 6 is a block diagram of a computer system on which embodiments of the present disclosure may be implemented.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Current digital media platforms, both the platforms that focus on audio, such as podcasting platforms, or social platforms like Twitter and Facebook that have support for audio content, treat the audio content as a monolithic piece of content (one produced media file that can be played back) which is created in a synchronous manner (a podcast recording session where all participants are available at the same time).

This disclosure describes a format where each participant in a conversation can record their audio content separately, at their own time and post it to the conversation thread. This is an asynchronous format that does not rely on all participants being available at the same time. Further, each such audio content, may be automatically transcribed and processed to generate a small snippet(s) of text that is associated with the audio content. This results in a structured audio conversation media format that grows over time as participants add more replies. The structure makes it possible to quickly scan the conversation, see who has spoken and read their text snippets to gauge interest and then quickly navigate to portions of the audio content that are of more interest to the listener.

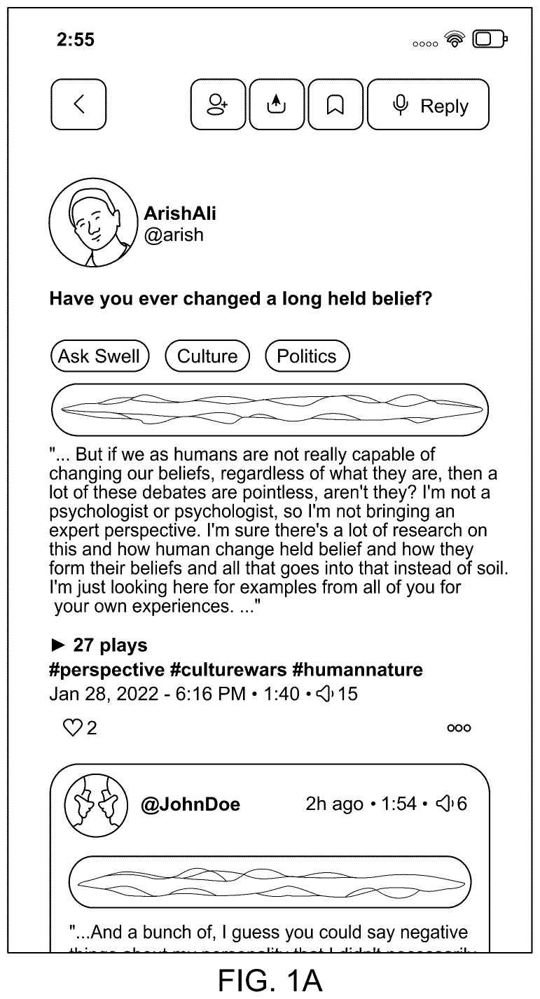

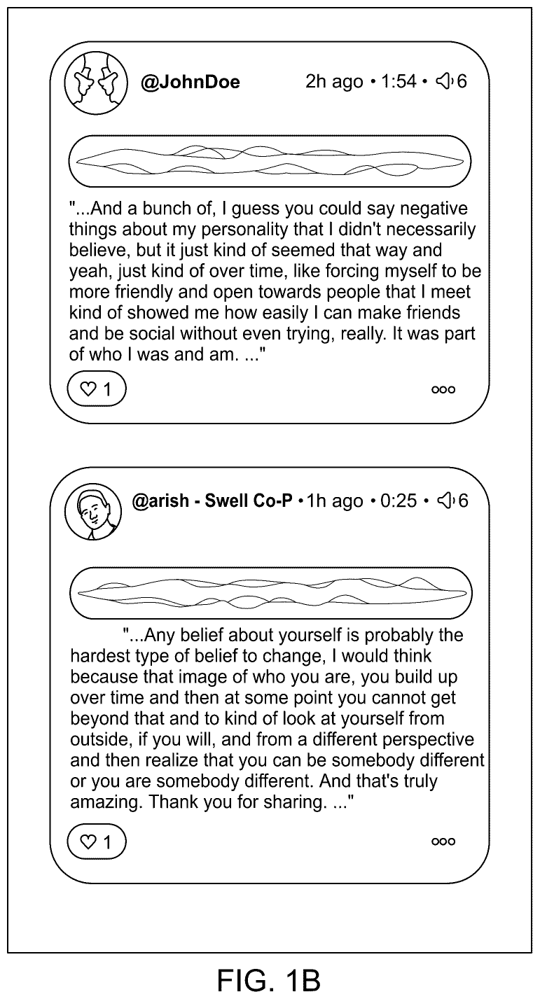

FIG. 1 is a screenshot showing structured conversation with asynchronous posted audio at different times along with the automatically generated text snippets for the various speakers. The screen of FIG. 1A is continued onto FIG. 1B.

Anyone interested in listening to audio content will be able to use these structured asynchronous audio conversations with text snippets to quickly uncover interesting audio portions of what otherwise might be a long conversation. From a content creator perspective, anyone creating content that has one or more people talking can use this format to create such content more easily with multiple participants and furthermore, make it easier and more engaging for the consumers to consume the content.

This approach makes it easier to create, navigate, browse and consume an audio conversation by letting each speaker participate asynchronously and by using artificial intelligence (AI) to automatically generate selective text snippets through transcription of each such asynchronous audio element of the conversation. This approach has the following benefits. For audio content creators, it frees them from having to get all speakers at the same time and place to record a conversation. For the listeners, the structured format makes it easy to browse the content, to read the text snippets while also listening to the conversation to be able to more quickly consume the conversation than they would be able to if they had to listen to the full conversation, or to read the full transcript to be able to consume it. If they like a particular text snippet, they can start playing that portion of the audio content instead of listening to the full conversation. Also, reading the text snippets and browsing any associated media uploaded by the speakers (links or images), keeps the user more engaged with the audio content.

The technology includes a platform for creating and consuming structured audio conversations, in the form of a website, an application or other digital form, where users and businesses may come together to create and consume audio conversations with one or more speakers.

The primary mode of communication is audio, with visuals to augment audio as the need may be. This description below first explains how a mobile applicable embodiment functions. The same would apply to web based, PC based, or other technical implementations.

A user comes and starts an audio conversation by creating and posting the first audio recording along with associated meta data. As he goes to create his message, he is presented with an audio recorder interface. He can speak what he wishes to convey and it is recorded. He may optionally save and resume his recording at a later point. He may also record over some elements of his recording, should he wish to alter some of his content. He is able to add meta data to the audio recording. The meta data may include but is not limited to title, description, optional media files like photos and images, category names, hashtags and search terms.

The user can also be provided a digital audio studio which he can use to edit the recording. Some examples (and not all consuming) of such edits are:
Intersperse sounds and music from a library of available sounds and music in the studio and in the user's device or computer into the audio message by overlaying tracks to play in parallel, in sequence, fade in and out and such.
Morph the tracks to stretch, shorten or otherwise alter the voices to induce effects that can be humorous, dramatic or other.
Identify and tag different users whose voices are in the audio. This may happen automatically as well using AI and the user can edit the AI's tagging, should he wish to.

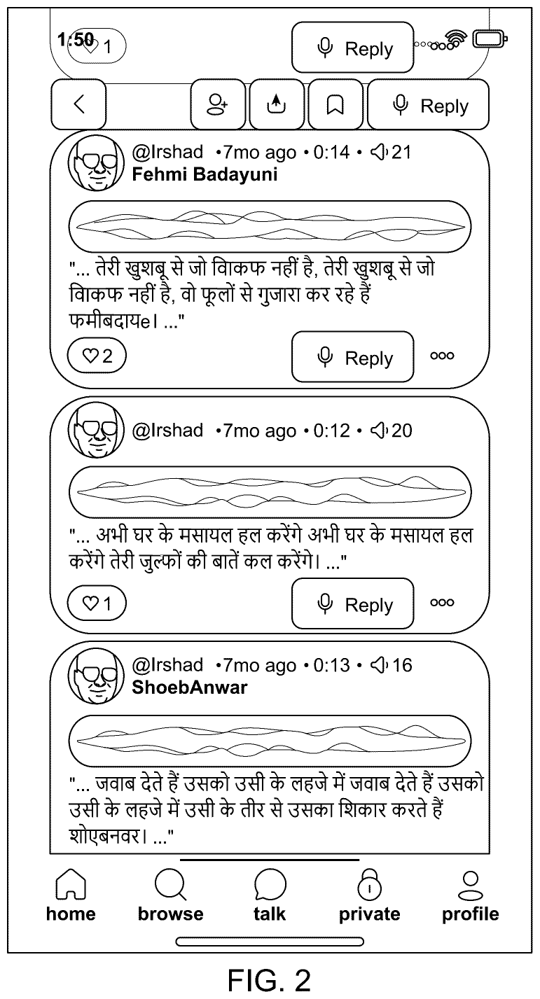

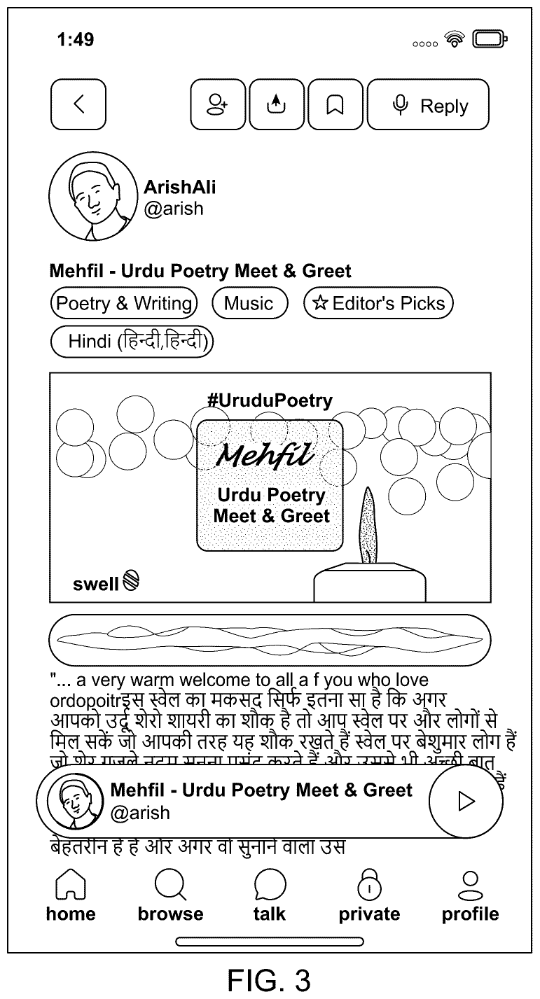

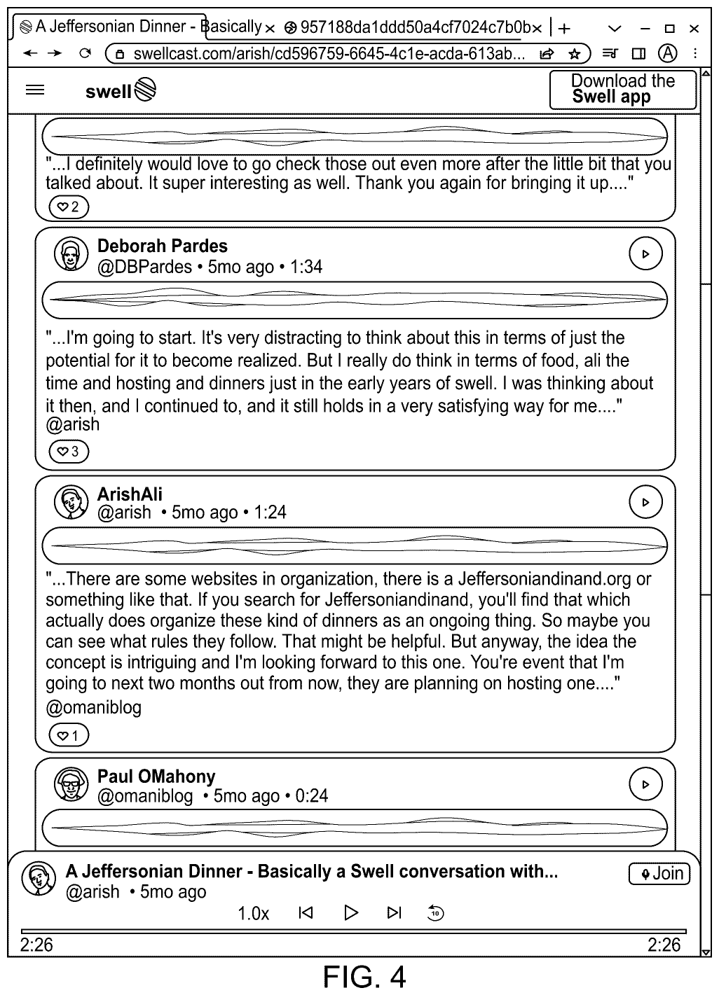

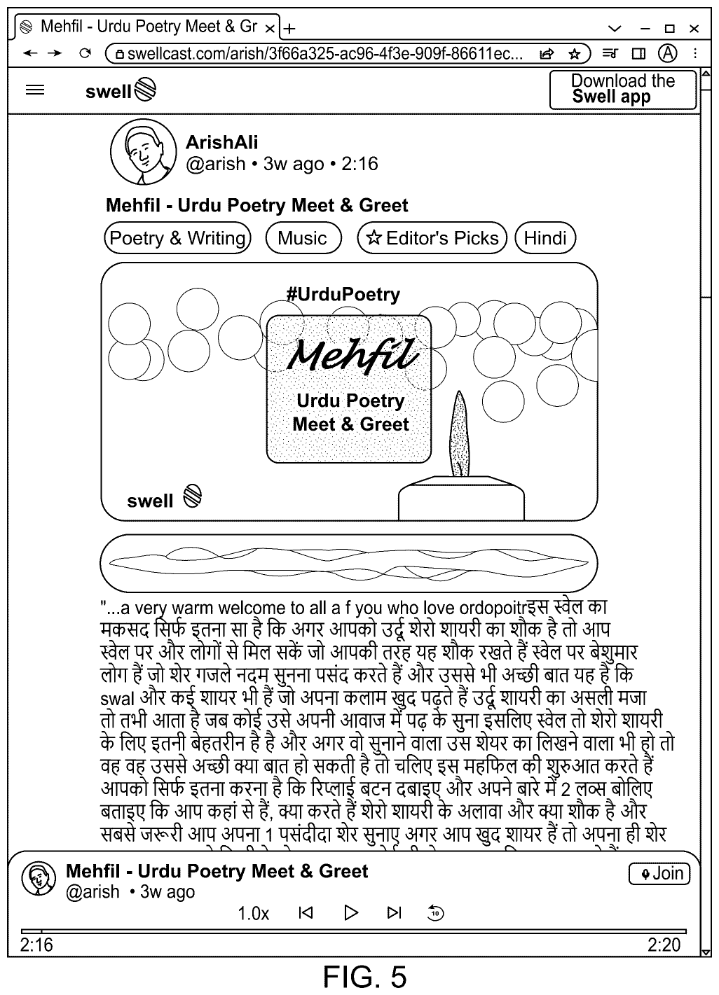

After completing the recording, the user posts it. When the recording is posted, the system transcribes the recording using AI and/or human enabled system. The system also selects one or more subsets of the transcription, each called a “snippet”, and associates them with the recording. The audio, transcription and the snippets can be in any language. For example, see FIG. 2 for an example of text snippets in another language, Hindi, and see FIG. 3 for an example of a mixed language text snippet where the transcription is in English and Hindi both. FIGS. 2 and 3 are screens from a mobile app. The disclosure is not limited to mobile apps. For example, FIGS. 4 and 5 are screens from a website.

Other users can see this conversation and can listen to it and also view the associated metadata such as title, description, images and the text snippet. A user can join the conversation by replying to it with their own audio recording and their own associated meta data. The system again automatically transcribes and generates a text snippet for their reply and adds it to the original conversation. The original user can reply back to this conversation in the same manner and new users can join in at any time. This allows the conversation to grow with multiple replies getting added to the same conversation.

Users can browse this conversation, listen to it as a whole by listening to each audio file one by one, or simply scan the structured content and skip to various portions of interest based on the associated text snippet and other metadata for that portion.

The user who creates the original conversation can also choose to limit who can speak in the conversation and who can listen to the conversation. For example, only invited speakers may be allowed to speak but anyone can listen. Or the conversation may be limited as a private conversation between specific in individuals or limited to a specific group of users.

The text snippet that is generated for each recording in the conversation is an important element of the structured conversation browsing experience. Different algorithms and strategies can be used to automatically generate the text snippets to determine the best type for any particular application. Below is a non-exhaustive list of examples of how the snippet may be generated:
The snippet can be generated by using AI to understand the topics the user is talking about in the recording, and then selecting one or more sentences from the recording that best reflect that topic.
Another technique could be for the AI to select a portion of the audio that best captures the essence of what the speaker is saying or summarizes what the speaker is saying.
Another technique could be for the AI to understand the topic of the original post that started the conversation and then select a text snippet in each reply that is most relevant to the original topic.
Another technique could be to capture a sound bite which people are most likely to respond to—for example, a sentence that includes a phrase or word that is trending in the media right now.
Another technique could be to understand the full audio, and then summarize it in a text snippet.
Another technique could be to just select a portion of audio at random.
Yet another technique could be to just take the first few sentences, middle few or last few sentences from each recording and convert that to a text snippet.
Yet another technique is to listen to voice intonations and emphases and determine the important portion to include in the snippet.
Yet another technique can be to select text snippets that includes words or phrases that are preselected and stored in a database.

The various technique above can make use of AI or other technologies to select the snippet. For example, in some cases it may be better to use human editors, moderators or crowd sourcing to generate the best snippets. Some applications may also allow the end user to update their text snippets.

For different applications, different snippet techniques may work better or worse. Implementations may also support having different “snippet engines” supporting different techniques and/or types of snippets, and the system can dynamically change the snippet techniques to determine the best one based on various success metrics such as but not limited to average listen duration, number of new replies, sharing or any combination thereof. The snippet technique can be changed for the whole application, for different conversations, or even for different replies within a given conversation such that one reply can have a snippet generated by one technique and the next reply can be using a different technique and the system can dynamically determine the best one in each case.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

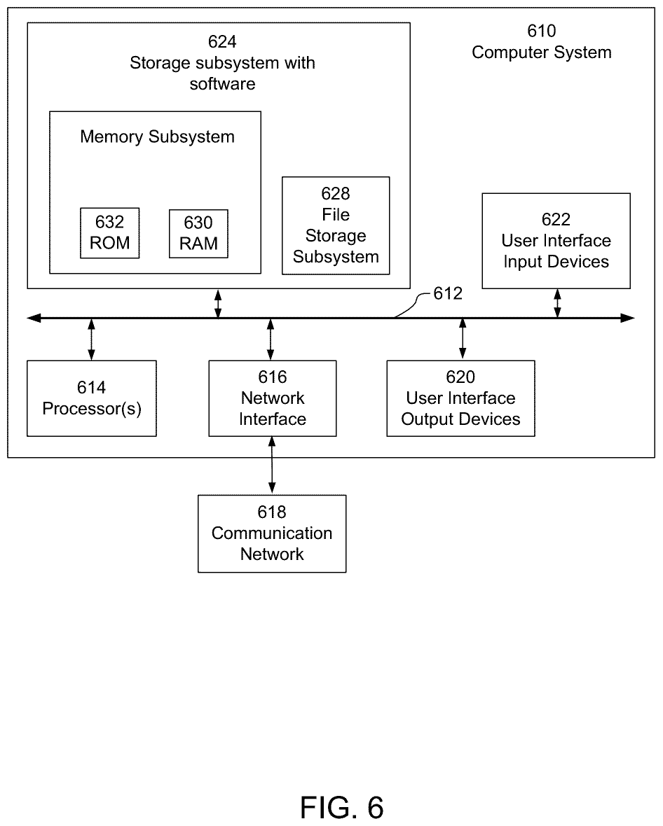

Alternate embodiments are implemented in computer hardware, firmware, software, and/or combinations thereof. Implementations can be implemented in a computer program product tangibly embodied in a computer-readable storage device for execution by a programmable processor; and method steps can be performed by a programmable processor executing a program of instructions to perform functions by operating on input data and generating output. FIG. 6 is a block diagram of a computer system 610 on which embodiments of the present disclosure may be implemented. Embodiments can be implemented advantageously in one or more computer programs that are executable on a programmable computer system 610 including at least one programmable processor 614 coupled to receive data and instructions from, and to transmit data and instructions to, a data storage system 624, at least one input device 622, and at least one output device 620. Each computer program can be implemented in a high-level procedural or object-oriented programming language, or in assembly or machine language if desired; and in any case, the language can be a compiled or interpreted language. Suitable processors 614 include, by way of example, both general and special purpose microprocessors. Generally, a processor will receive instructions and data from a read-only memory 632 and/or a random access memory 630. Generally, a computer will include one or more mass storage devices 628 for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. The computer system 610 may include a network interface 616 for connection to an external communication network 618. The components within the computer system 610 may communicate via an internal bus 612. Any of the foregoing can be supplemented by, or incorporated in, ASICs (application-specific integrated circuits), FPGAs and other forms of hardware.

What is claimed is:

1. A method comprising:
receiving one or more audio recordings that are part of a conversation by one or more speakers;
using speech recognition to convert the audio recordings to full text transcriptions of the audio recordings;
applying artificial intelligence to generate text snippets from the full text transcriptions; and
posting the text snippets alongside the corresponding audio recordings.

2. The method of claim 1, wherein generating the text snippets occurs asynchronously as the audio recordings are received.

3. The method of claim 2, wherein new text snippets are generated when speakers speak, and the new text snippets are added to previously generated text snippets to create a growing thread of the conversation.

4. The method of claim 1, wherein the audio recordings are posted before the text snippets are available, and the text snippets are posted later alongside the audio recordings.

5. The method of claim 1, wherein generating the text snippets from the full text transcriptions comprises: the artificial intelligence detecting topics from the full text transcriptions and then selecting one or more sentences from the full text transcriptions about the detected topics.

6. The method of claim 1, wherein generating the text snippets from the full text transcriptions comprises: the artificial intelligence selecting portions of the full text transcriptions that summarize what speakers are saying.

7. The method of claim 1, wherein generating the text snippets from the full text transcriptions comprises: the artificial intelligence detecting a topic of an original posting that started the conversation and then selecting text snippets from replies that are about the detected topic.

8. The method of claim 1, wherein generating the text snippets from the full text transcriptions comprises: the artificial intelligence selecting portions of the full text transcriptions that include words or phrases that are trending online and/or that are preselected.

9. The method of claim 1, wherein generating the text snippets from the full text transcriptions comprises: the artificial intelligence summarizing the full text transcriptions.

10. The method of claim 1, wherein generating the text snippets from the full text transcriptions comprises: the artificial intelligence selecting randomly from the full text transcriptions.

11. The method of claim 1, wherein generating the text snippets from the full text transcriptions comprises: the artificial intelligence selecting the first sentences, middle sentences or last sentences of the full text transcriptions and combining the selected sentences.

12. The method of claim 1, wherein the artificial intelligence also uses the audio recordings to generate the text snippets from the full text transcriptions.

13. The method of claim 12, wherein the artificial intelligence determines emphases in the full text transcriptions based on voice intonations from the corresponding audio recordings, and generates the text snippets based on the emphases in the full text transcriptions.

14. The method of claim 1, further comprising:
detecting a language spoken by one of the speakers; and
translating text snippets in different languages to the detected spoken language.

15. The method of claim 1, wherein the text snippets are in multiple languages based on languages spoken in the audio recordings.

16. The method of claim 1, wherein the artificial intelligence dynamically switches between different techniques for generating the text snippets based on a success metric.

17. The method of claim 16, wherein the success metric is based on at least one of (i) how many speakers listen to the audio recordings after viewing the text snippets, (ii) how many speakers participate in the conversation by replying after viewing the text snippets, and (iii) how many speakers share the conversation after viewing the text snippets.

18. The method of claim 1, wherein the one or more audio recordings comprise a plurality of audio recordings that are part of the conversation between multiple speakers.

19. A non-transitory computer-readable storage medium storing executable computer program instructions for enhancing audio conversations, the instructions executable by a computer system and causing the computer system to:
receive one or more audio recordings that are part of a conversation by one or more speakers;
use speech recognition to convert the audio recordings to full text transcriptions of the audio recordings;
apply artificial intelligence to generate text snippets from the full text transcriptions; and
post the text snippets alongside the corresponding audio recordings.

20. A computer system for enhancing audio conversations, the computer system comprising:
a non-transitory storage medium for storing instructions; and
a processor system having access to the storage medium and executing the instructions, wherein the instructions when executed cause the processor system to:
receive a plurality of audio recordings that are part of a conversation between two or more speakers;
use speech recognition to convert the audio recordings to full text transcriptions of the audio recordings;
apply artificial intelligence to generate text snippets from the full text transcriptions; and
post the text snippets alongside the corresponding audio recordings.
